(19) United States
(12) Patent Application Publication
(10) Pub. No.: US 2003/0079504 A1
(43) Pub. Date: May 1, 2003

(54) Methods and apparatus for forming a chlorine-doped optical waveguide preform

(76) Inventors: Heather D. Boek, Corning, NY (US); Pushkar Tandon, Corning, NY (US)

Correspondence Address: MYERS BIGEL SIBLEY & SAJOVEC, PO BOX 37428, RALEIGH, NC, 27627, US

(21) Appl. No.: 10/035,535

(22) Filed: Oct. 26, 2001

(51) Int. Cl. C03C 25/64

(52) U.S. Cl. 65/424; 65/426; 65/529

(57) ABSTRACT

A method of manufacturing an optical waveguide perform includes exposing a soot preform to an atmosphere including a chlorine-containing compound and thereby doping the soot preform with chlorine, wherein the absolute pressure of the atmosphere is greater than about 1.013×10² kPa. An apparatus for manufacturing an optical waveguide preform using a soot preform includes a furnace defining a chamber adapted to contain the soot preform and including a heating device operable to heat the chamber. A fluid control system is operable to provide an atmosphere including a chlorine-containing compound in the chamber at an absolute pressure of greater than about 1.013×10² kPa.

### FIELD OF THE INVENTION

The present invention relates to optical waveguides, and, more particularly, to methods for forming optical waveguide preforms.

### BACKGROUND OF THE INVENTION

Optical waveguides or fibers formed of glass may be drawn from a preform at suitable drawing temperatures, typically between about 1600 and 2150° C. Commonly, such an optical fiber is formed having a core of a first material and a cladding of a second material. At drawing temperatures, the core material and the cladding material may have different viscosities from one another. The layer having a higher viscosity may be placed under tensile stress in the fiber once the fiber has cooled. Such tensile stresses may induce weaknesses that make the fiber or portions thereof subject to mechanical and/or optical failure during manufacture or in use. Where the viscosity of the core material is greater than that of the cladding material, such tensile stresses may increase the attenuation in or otherwise diminish the optical properties of the core.

A portion (e.g., corresponding to the core of the fiber) of a preform may be doped with chlorine to reduce the viscosity of the portion during draw. For example, the preform may be chlorine doped by exposing a soot preform from which the preform is formed to an atmosphere of chlorine during consolidation (i.e., before and/or during sintering) of the soot preform. However, known methods of chlorine doping may not provide sufficient doping levels to provide desired viscosity matching or tuning for a number of fiber designs.

### SUMMARY OF THE INVENTION

According to method embodiments of the present invention, a method of manufacturing an optical waveguide perform includes exposing a soot preform to an atmosphere including a chlorine-containing compound and thereby doping the soot preform with chlorine. The absolute pressure of the atmosphere is greater than about 1.013×10² kPa.

According to further method embodiments of the present invention, a method of manufacturing an optical waveguide perform includes exposing a soot preform to an atmosphere including a chlorine-containing compound for a period of at least 60 minutes and thereby doping the soot preform with chlorine wherein: the absolute pressure of the atmosphere is greater than about 1.013×10² kPa; the mole percentage of chlorine present in the atmosphere is greater than about 20%; the weight percentage of chlorine present in the soot preform is greater than about 1%; the chlorine-containing compound is selected from the group consisting of SiCl₄, Cl₂, CCl₄, SOCl₂ and POCl₃; and the atmosphere is at a temperature of at least about 1000° C.

According to embodiments of the present invention, an apparatus for manufacturing an optical waveguide preform using a soot preform includes a furnace defining a chamber adapted to contain the soot preform and including a heating device operable to heat the chamber. A fluid control system is operable to provide an atmosphere including a chlorine-containing compound in the chamber at an absolute pressure of greater than about 1.013×10² kPa.

Objects of the present invention will be appreciated by those of ordinary skill in the art from a reading of the figures and the detailed description of the preferred embodiments which follow, such description being merely illustrative of the present invention.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a flow chart representing methods according to embodiments of the present invention for forming a chlorine-doped glass preform;

FIG. 2 is a schematic diagram of an apparatus according to embodiments of the present invention for forming a chlorine-doped preform; and

FIG. 3 is a cross-sectional view of a multi-layer glass preform formed using a method of the present invention.

### DETAILED DESCRIPTION OF THE INVENTION

The present invention now will be described more fully hereinafter with reference to the accompanying drawings in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

Methods and apparatus according to the present invention may be used to provide enhanced levels of chlorine doping in a soot preform. The chlorine-doped soot preform may in turn be consolidated to form a glass preform or a layer of a glass preform wherein the preform or layer exhibits an enhanced level of chlorine doping.

In the case of a multi-layer preform, the enhanced level of chlorine doping in the chlorine-doped layer may provide a corresponding reduction in the viscosity of the layer in a selected draw temperature range, which may in turn provide improved viscosity matching or tuning between the chlorine-doped layer and another layer of the glass preform in the draw temperature range. The improved viscosity matching or tuning may reduce or minimize the tensile or compressive stresses resulting from differential viscosities during the process of drawing a fiber from the glass preform or may allow for selective and desired creation and control of such stresses. The chlorine doping may provide the foregoing effect without appreciably altering the refractive index of the chlorine-doped layer.

Enhanced chlorine doping of the soot preform may also be advantageous for reducing thermal stress from linear thermal expansion (LTE) mismatch, reducing mechanical stress from viscosity mismatch, lowering impurities, and controlling refractive index.

By way of example, it may be desired to form an optical waveguide or fiber including a core of GeO₂—SiO₂ and another layer of F—SiO₂. The glass preform from which the fiber is to be drawn must likewise have a core or inner layer of GeO₂—SiO₂and an outer layer of F—SiO₂. Because the GeO₂—SiO₂ of the glass preform core has a higher viscosity than the F—SiO₂ of the glass preform outer layer, the core of the cooled fiber may be maintained under tensile stress by the outer layer. By doping the core of the glass preform with chlorine, the viscosity of the core may be lowered to match that of the outer layer, or even to be less than the viscosity of the outer layer so that the core is under zero tension or compression in the cooled fiber. In one embodiment, the outer layer corresponds to a moat region of the core. However, the outer later may alternatively be a cladding layer.

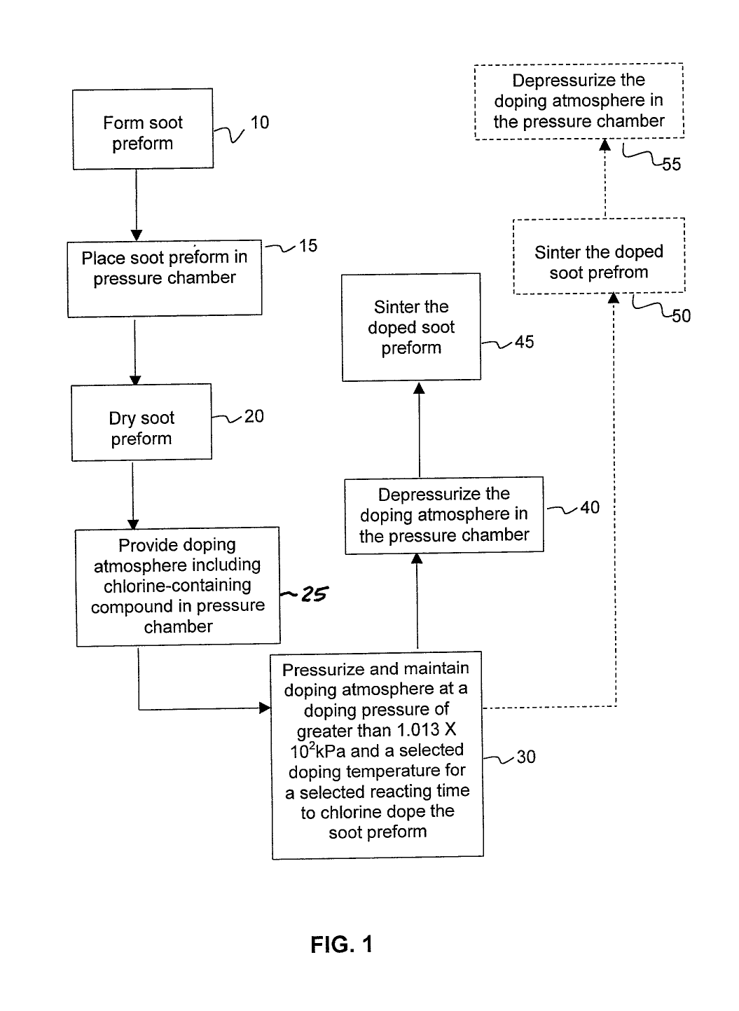

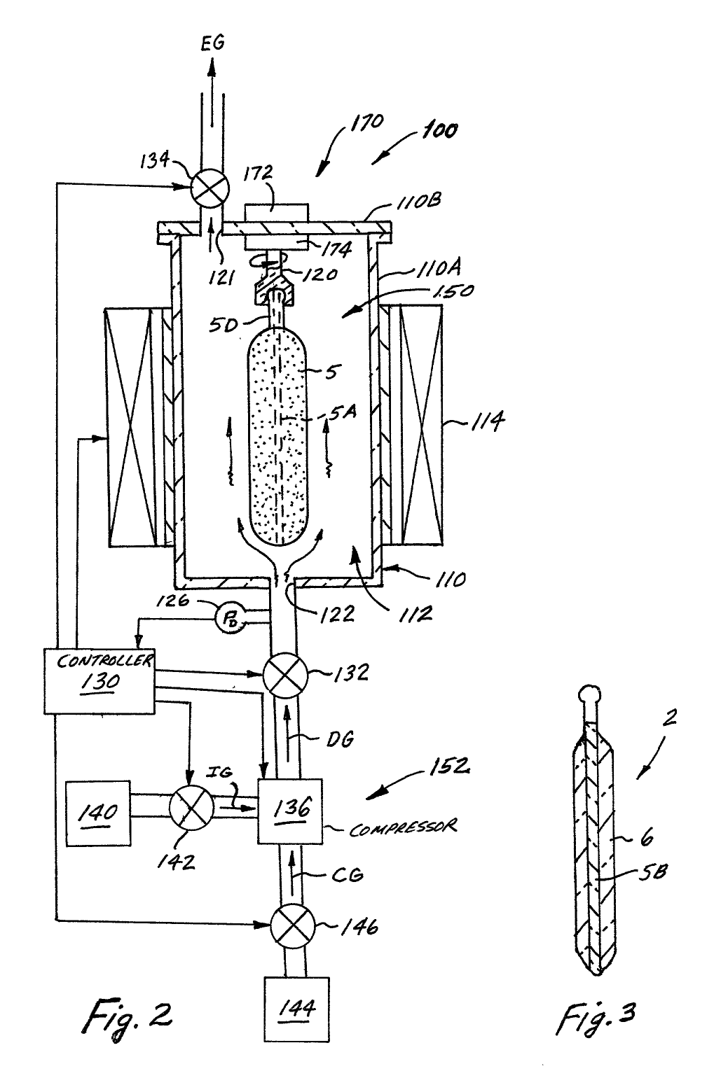

A soot preform may be doped and consolidated using a method according to embodiments of the present invention as represented by the flow chart of FIG. 1 and an apparatus 100 as schematically illustrated in FIG. 2.

A soot preform 5 (FIG. 2) is formed using any suitable method (Block 10), such as chemical vapor deposition (CVD). Suitable methods for forming soot preforms are known to those of skill in the art and include outside vapor deposition (OVD). For example, U.S. Pat. No. 3,933,454 discloses suitable methods and apparatus for forming a soot preform. The soot preform 5 may be formed of pure silica or may be formed of doped silica (for example, silica doped with Ge, Al, F, B, Er, Ti, P and/or Sb). The soot preform 5 may include suitable glass modifiers or glass formers such as SiO₂, Al₂O₃, Er₂O₃, TiO₂, F, or GeO₂. The soot preform 5 is a porous structure defining a plurality of interstices. Preferably, the soot preform 5 includes a passage 5A extending the full length thereof from which a mandrel of the chemical vapor deposition apparatus has been removed. The soot preform may include a glass preform handle 5D as illustrated.

The apparatus 100 includes a pressure vessel 110 defining a pressure chamber 112. The vessel includes an annular muffle 110A and an end cover 110B. Preferably, the end cover 110B is mounted on the vessel 110 so as to provide a high pressure, gas-tight seal therebetween. A handle 120 extends from the end cover 110B and into the chamber 112. A drive system 170 is mounted on the vessel 110. The drive system 170 includes a drive motor 172 mounted on the exterior side of the end cover 110B and a transmission unit 174 mounted on the interior side of the end cover 110B. The drive motor 172 is magnetically coupled to the transmission unit 174 through the end cover 110B such that the transmission rotates the handle 120 and thereby the preform 5 (preferably and as shown, about a vertical axis). The drive system 170 allows rotation of the preform 5 without requiring a seal between relatively moving parts.

The apparatus 100 may include a conventional consolidation furnace with suitable modifications. For example, it may be necessary to reinforce the pressure vessel 110 to withstand the relatively large internal doping pressures as discussed below. Preferably, the chamber 112 and the soot preform 5 are substantially completely surrounded by a pure silica muffle.

The soot preform 5 is placed in the pressure chamber 112 and suspended from the handle 120 (Block 15). If rotation is provided, the soot preform 5 may be suspended from the handle 120 for rotation therewith. Optionally, the soot preform 5 may be dried by passing a flow of suitable drying gas through the chamber 112 and about the soot preform 5 to remove water and hydroxyl ions from the soot preform 5 (Block 20). Preferably, the drying gas (preferably a chlorine-containing gas) is provided at a flow rate of between about 10 and 40 slpm for a time of between about 30 and 90 minutes while the soot preform 5 is maintained at a temperature of between about 1000 and 1200° C. Suitable drying gases include Cl₂, GeCl₄, SiCl₄, CCl₄, SOC₂ and POCl₃. The pressure chamber 112 may be heated using a heating device 114 (e.g., a resistive heater or an inductive coil heater). The flow of drying gas may be provided using a fluid control system 152 as described below or other suitable means.

A doping atmosphere 150 is provided in the pressure chamber 112 about the soot preform 5 (Block 25). The doping atmosphere is provided using the fluid control system 152. The fluid control system 152 includes a controller 130, a chamber inlet valve 132, a chamber outlet valve 134, a compressor 136, a supply 140 of carrier gas IG, a carrier gas valve 142, a supply 144 of a chlorine-containing gas CG (i.e., a gas including a chlorine-containing compound), a chlorine gas valve 146 and a pressure gauge 126. The valves 132, 134, 142 and 146 and the compressor 136 may be controlled by the controller 130.

Initially, the valves 132 and 134 are opened to provide a flow path from the compressor 136 and through an inlet 122, the chamber 112 and an outlet 121. The compressor 136 and the valves 142 and 146 are cooperatively operated to form a doping gas DG including desired proportions of the carrier gas IG and the chlorine-containing gas CG, and to force the doping gas DG into the pressure chamber 112. The valve 134 is left open until the atmosphere previously in the chamber 112 is purged and the chamber 112 is substantially completely filled with the doping gas DG.

After the pressure chamber 112 is substantially filled with the doping gas DG, the controller 130 operates the compressor 136 and the valves 142, 146 to introduce a selected mass of the doping gas DG into the chamber 112, thereby forming the doping atmosphere 150. The controller 130 farther operates the valves 132, 134, the compressor 136 and/or the heating device 114 to pressurize the doping atmosphere 150 to a selected doping pressure P_{D}, and to heat the doping atmosphere 150 to a selected doping temperature. This may be accomplished by closing the outlet valve 134, maintaining the doping atmosphere 150 at the selected doping temperature T_{D}, and continuing to force the doping gas DG into the chamber 112 until the doping atmosphere 150 attains the doping pressure P_{D} (as indicated to the controller 130 by the gauge 126). The valve 132 may be closed to maintain the doping atmosphere 150 at the doping pressure P_{D} while the heating device 114 maintains the temperature of the doping atmosphere 150 at the doping temperature T_{D}.

It will be appreciated by those of skill in the art from the description herein that other methods for providing the doping atmosphere 150 with the doping pressure P_{D} and, simultaneously, the doping temperature T_{D} may be employed. For example, the doping atmosphere 150 may be maintained at a filling temperature T_{F} and pressurized to a filling pressure P_{F}, the filling temperature T_{F} and the filling pressure P_{F} being selected such that, when the chamber 112 is sealed and the doping atmosphere 150 is heated to the doping temperature T_{D}, the pressure of the doping atmosphere 150 will equal the doping pressure P_{D}.

The doping atmosphere 150 is maintained in the pressure chamber 112 about the soot preform 5 at the doping pressure P_{D} and the doping temperature T_{D} for a selected reacting time t_{R}. The doping pressure P_{D} is at least 1.013×10² kPa and the doping temperature T_{D} and the reacting time t_{R} are selected to provide a selected level of chlorine doping to the soot preform 5. The chlorine present in the doping gas DG reacts with and diffuses into the porous soot preform 5 such that the soot preform 5 is doped with an elevated level of chlorine. The soot preform 5 may be rotated during the reacting time t_{R}. Preferably, the pressure vessel 110 is sealed gas-tight throughout the reacting time t_{R}.

Preferably, the absolute doping pressure P_{D} is at least about 2.026×10² kPa. More preferably, the absolute doping pressure P_{D} is between about 4.052×10² kPa and 16.32×10² kPa. Preferably, the doping partial pressure PP_{D} of the chlorine-containing gas CG is maintained substantially constant throughout the reacting time t_{R}, for example, by the addition of chlorine-containing gas CG into the chamber while maintaining the exhaust valve 134 closed. However, the doping partial pressure PP_{D} may be varied. Preferably, the doping pressure P_{D} does not vary by more than 10% throughout the reacting time t_{R}.

Preferably, the doping temperature T_{D} is at least about 1000° C. More preferably, the doping temperature T_{D} is between about 1250 and 1350° C. Preferably, the doping temperature T_{D} does not vary by more than about 1% throughout the reacting time t_{R}.

Preferably, the mole percentage of chlorine in the doping atmosphere 150 is greater than about 20%. More preferably, the mole percentage of chlorine present in the doping atmosphere 150 is between about 20 and 40%.

Preferably, the reacting time t_{R} is at least 60 minutes. More preferably, the reacting time t_{R} is between about 60 and 180 minutes.

The weight percentage of chlorine present in the doped soot preform 5 may be selected as needed to match viscosity, linear thermal expansion (LTE), refractive index, and/or other selected properties. Preferably, the weight percentage of chlorine present in the doped soot preform 5 is greater than 1%. More preferably, the weight percentage of chlorine present in the doped soot preform 5 is between about 1 and 1.5%.

The chlorine-containing gas CG may include one or more of the following: GeCl₄, SiCl₄, Cl₂, CCl₄, SOCl₂ and POCl₃. Preferably, the chlorine-containing gas CG includes SiCl₄ or Cl₂. Suitable carrier gases IG include He, Ar, CO, and N₂.

At the end of the reacting time t_{R}, the doping atmosphere 150 is depressurized (Block 40). Exhaust gases EG such as SiCl₄, GeO, Cl₂, O₂, He, Ar or N₂ may be expelled through the outlet 121 by opening the valve 134. If desired, the pressurized doping step may be repeated to further dope the soot preform 5. Following the last doping step, the soot preform 5 may be sintered (i.e., consolidated) to form a doped glass preform. The sintering step may include heating the doped soot preform 5 in the pressure chamber 112 using the heating device 114 and/or another heating device to sinter the soot preform 5 using known or other suitable techniques. Preferably, the sintering step includes heating the soot preform 5 to a temperature of between about 1300 and 1600° C.

Alternatively, the doped soot preform may be sintered (Block 50) at the end of the reacting time (Block 30). The doping atmosphere 150 may thereafter be depressurized (Block 55). As discussed above, multiple doping cycles may be conducted prior to the sintering step (Block 50). Preferably, the sintering step of Block 55 is conducted in the same manner and using the same parameters as discussed above with regard to the sintering step of Block 45.

In known manner, the chlorine-doped glass preform may be drawn and sectioned to form a chlorine-doped glass cane. A second, outer layer of silica soot may be deposited about the glass cane using a suitable deposition method such as OVD. The outer soot layer is in turn consolidated about the chlorine-doped glass cane to form a multi-layered glass preform 2 as shown in FIG. 3. The preform 2 includes a core 5B formed from the consolidated, chlorine-doped soot preform 5, and an outer layer 6 formed from the consolidated outer soot layer.

The layers 5B and 6 may be characterized in that the materials from which the layers 5B and 6 are formed, absent the chlorine doping of the layer 5B, have different viscosities from one another at drawing temperatures in the range of between about 1600 and 2150° C. The chlorine doping of the layer 5B may serve to provide closer matching of the inner layer 5B and the outer layer 6 at the drawing temperatures than is provided if the inner layer 5B were not chlorine doped in accordance with the present invention. Preferably, the inner layer 5B is formed of chlorine-doped, SiO₂—GeO₂. Preferably, the outer layer 6 is formed of F—SiO₂. Optionally, the inner layer 5B may be formed of chlorine-doped silica and the outer layer 6 fluorine-doped silica.

The foregoing multi-layer preform 2 includes a chlorine-doped core. However, inner layers other than the core may be chlorine doped and the outer layer may be a cladding layer. The inner layer may be an inner section of the core with the outer layer being an outer section of the core. Similarly, the chlorine-doped layer may be an inner section of the cladding with the outer layer being a more outer section of the cladding.

Notably, by sealing the pressure chamber 112 throughout the reacting time t_{R}, the amount of unreacted chlorine exhausted may be substantially reduced. Moreover, the overall amount of the exhaust gases is substantially reduced. Accordingly, the significant cost of the doping gas DG and the significant cost of treating, recycling or disposing of the exhaust gases may be correspondingly reduced.

As noted above, the pressure chamber 112 is preferably fully sealed throughout the reacting time t_{R}. However, the aforedescribed methods may be modified to include providing a flow of doping gas DG into the pressure chamber 112 and a substantially equal flow of exhaust gas EG out of the pressure chamber, while maintaining the doping atmosphere at the doping pressure P_{D}.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

What is claimed is:

1. A method of manufacturing an optical waveguide preform, said method comprising:
exposing a soot preform to an atmosphere including a chlorine-containing compound and thereby doping the soot preform with chlorine, wherein the absolute pressure of the atmosphere is greater than about 1.013×10² kPa.

2. The method of claim 1 including, prior to said step of exposing the soot preform, inserting the soot preform into a consolidation furnace.

3. The method of claim 1 including:
drying the soot preform prior to said step of exposing the soot preform; and
sintering the soot preform following said step of exposing the soot preform.

4. The method of claim 1 wherein the mole percentage of chlorine present in the atmosphere is greater than about 20%.

5. The method of claim 1 wherein the mole percentage of chlorine present in the atmosphere is between about 20% and 40%.

6. The method of claim 1 wherein the weight percentage of chlorine present in the soot preform is greater than about 1%.

7. The method of claim 1 wherein the weight percentage of chlorine present in the soot preform is between about 1.0% and 1.5%.

8. The method of claim 1 wherein the chlorine-containing compound is selected from the group consisting of GeCl₄, SiCl₄, Cl₂, CCl₄, SOCl₂, POCl₃ and combinations thereof.

9. The method of claim 1 wherein the atmosphere is at a temperature of at least about 1000° C.

10. The method of claim 1 wherein the atmosphere is at a temperature of between about 1250 and 1350° C.

11. The method of claim 1 wherein the absolute pressure of the atmosphere is greater than about 2.026×10² kPa.

12. The method of claim 1 wherein the absolute pressure of the atmosphere is between about 4.052×10² and 16.32×10² kPa.

13. The method of claim 1 including exposing the soot preform to the atmosphere for a period of at least 60 minutes.

14. The method of claim 1 including exposing the soot preform to the atmosphere for a period of between about 60 and 180 minutes.

15. The method of claim 1 wherein the soot preform includes silica and a material selected from the group consisting of germanium, fluorine, boron, phosphorous, erbium, antimony, aluminum, and titanium.

16. The method of claim 1 including forming the optical waveguide preform such that the optical waveguide preform includes an inner layer formed from the chlorine doped soot preform and an outer layer surrounding the inner layer, wherein:
the soot preform and the outer layer are formed of materials having different viscosities at drawing temperatures in the range of between about 1600 and 2150° C.; and
the chlorine doping of the soot preform improves matching of the viscosities of the inner layer and the outer layer at said drawing temperatures as compared to a non-chlorine doped inner layer.

17. The method of claim 16 wherein the inner layer includes silica and a material selected from the group consisting of germanium, fluorine, boron, phosphorous, erbium, antimony, aluminum and titanium.

18. The method of claim 17 wherein the outer layer includes silica and a material selected from the group consisting of boron, phosphorous and fluorine.

19. A method of manufacturing an optical waveguide preform, said method comprising:
exposing a soot preform to an atmosphere including a chlorine-containing compound for a period of at least 60 minutes and thereby doping the soot preform with chlorine, wherein:
the absolute pressure of the atmosphere is greater than about 1.013×10² kPa;
the mole percentage of chlorine present in the atmosphere is greater than about 20%;
the weight percentage of chlorine present in the soot preform is greater than about 1%;
the chlorine-containing compound is selected from the group consisting of GeCl₄, SiCl₄, Cl₂, CCl₄, SOCl₂, POCl₃ and combinations thereof, and
the atmosphere is at a temperature of at least about 1000° C.

20. The method of claim 19 including, prior to said step of exposing the soot preform, inserting the soot preform into a consolidation furnace.

21. The method of claim 19 including:
drying the soot preform prior to said step of exposing the soot preform; and
sintering the soot preform following said step of exposing the soot preform.

22. The method of claim 19 wherein the mole percentage of chlorine present in the atmosphere is between about 20% and 40%.

23. The method of claim 19 wherein the weight percentage of chlorine present in the soot preform is between about 1.0% and 1.5%.

24. The method of claim 19 wherein the atmosphere is at a temperature of between about 1250° C. and 1350° C.

25. The method of claim 19 wherein the absolute pressure of the atmosphere is greater than about 2.6×10² kPa.

26. The method of claim 19 wherein the absolute pressure of the atmosphere is between about 4.052×10² and 16.32×10² kPa.

27. The method of claim 19 including exposing the soot preform to the atmosphere for a period of between about 60 and 180 minutes.

28. The method of claim 19 wherein the soot preform includes silica and a material selected from the group consisting of germanium, fluorine, boron, phosphorous, erbium, antimony, aluminum, and titanium.

29. The method of claim 19 including forming the optical waveguide preform such that the optical waveguide preform includes an inner layer formed from the chlorine doped soot preform and an outer layer surrounding the inner layer, wherein:
the soot preform and the outer layer are formed of materials having different viscosities at drawing temperatures in the range of between about 1600 and 2150° C.; and
the chlorine doping of the soot preform improves matching of the viscosities of the inner layer and the outer layer at said drawing temperatures as compared to a non-chlorine doped inner layer.

30. The method of claim 29 wherein the inner layer includes silica and a material selected from the group consisting of germanium, fluorine, boron, phosphorous, erbium, antimony, aluminum, and titanium.

31. The method of claim 30 wherein the outer layer includes silica and a material selected from the group consisting of boron, phosphorous and fluorine.

32. An apparatus for manufacturing an optical waveguide preform using a soot preform, said apparatus comprising:
a) a furnace defining a chamber adapted to contain the soot preform and including a heating device operable to heat said chamber; and
b) a fluid control system operable to provide an atmosphere including a chlorine-containing compound in said chamber at an absolute pressure of greater than about 1.013×10² kPa.

33. The apparatus of claim 32 wherein said fluid control system includes:
a flow control device selectively operable to prevent and allow flow of said atmosphere into and out of said chamber;
a pressurizing device operable to pressurize said atmosphere in said chamber to a selected pressure; and
a controller operative to control said flow control device and said pressurizing device.

34. The apparatus of claim 33 wherein said flow control device includes at least one valve.

35. The apparatus of claim 33 wherein said pressurizing device includes a compressor.
